(19) United States
(12) Patent Application Publication
(10) Pub. No.: US 2008/0077284 A1
(43) Pub. Date: Mar. 27, 2008

(54) System for position and velocity sense of an aircraft

(76) Inventor: John M. Swope, Davis, CA (US)

Correspondence Address: MATHEW J. TEMMERMAN, 423 E. STREET, DAVIS, CA, 95616, US

(21) Appl. No.: 11/788,716

(22) Filed: Apr. 19, 2007

Related U.S. Application Data
(60) Provisional application No. 60/745,158, filed on Apr. 19, 2006.

(51) Int. Cl. G05D 1/00; G06F 17/00; G06F 7/00

(52) U.S. Cl. 701/5; 701/4; 701/7

(57) ABSTRACT

A system for determining the position and/or velocity of an autonomous aircraft in a low-cost, low-weight manner independent of external technological dependencies such as satellites or beacons is claimed. The solution comprises a combination of traditional technologies (IMUs, altitude sensing, control systems, visual sensing technology, etc.) coupled with algorithms to implement their combined use. The solution is small enough for inclusion on small mass aircraft, yet its precision and capability make it useful for large aircraft as well. Utilizing the positional data, a series of control loops is claimed which allow an aircraft to autonomously take-off and land, station hold in a very precise manner, and fly in very close proximity to other objects with little chance of collision.

### RELATED APPLICATION

This application claims priority from the U.S. provisional application with Ser. No. 60/745,158, which was filed on 19 Apr. 2006. The disclosure of that provisional application is incorporated herein by reference as if set out in full.

### BACKGROUND OF THE INVENTION

1. Field of the Invention

The present invention relates to aircraft, specifically to methods for stability control, for facilitating take-offs and landings, and for enhancing flight capabilities in near-Earth environments.

2. General Background

There are many potential applications for the use of low-cost Vertical Take-Off and Landing (VTOL) unmanned aircraft. For various applications it is desirable to be able to control these unmanned craft remotely and/or autonomously. Aircraft control is a complex art that must take into account vehicle position and orientation, each in three dimensions. To control an aircraft, force is generally exerted by some means in one or more directions.

The control of unmanned aircraft is generally more difficult than that of manned aircraft due to the following as well as other factors: 1.) The relative position of remote operating pilot (remote operator) to aircraft changes as the aircraft moves and rotates in 3D space. This causes the controls to operate “backwards,” or “sideways,” or “rotated” depending on the orientation of the aircraft at any given moment. In a manned craft the controls do not change in this way because the remote operator is always positioned with the craft and generally facing forward. 2.) The remote operator must gather all flight data visually and does not have the advantage of his body moving with the aircraft. Thus, the remote operator must “feel” the movement of the aircraft with his eyes rather than also using his equilibrium.

VTOL aircraft are inherently more difficult to control than conventional airplanes. These kinds of aircraft include among others, helicopters, ducted fan-based systems, such as Honeywell's Micro Air Vehicle, and tilt-rotor wing systems such as the Boeing V-22 Osprey. The more radical designs are generally even more inherently unstable than a conventional helicopter. Therefore, in these cases, control systems that stabilize the attitude of the aircraft are often employed. Still, even with an attitude stabilization system, the aircraft is susceptible to being pushed about by wind or random drift. So for these and for the helicopter in general, a great level of skill and precision is required of the remote operator in order to operate the aircraft near the ground or other obstacles. Hence, the capability of precise position and velocity sensing are very desirable if the UAV is to be autonomous or is to require little skill or input from the remote operator.

In a traditional manned VTOL aircraft, the pilot is responsible for reading and responding to data associated with position and velocity. The pilot is generally able to see the ground and other obstacles outside the aircraft, and command the aircraft accordingly in order to avoid striking the obstacles and to provide a smooth landing and take-off.

As an example of the adaptability and responsiveness of a human pilot, one need only consider the task of landing a helicopter during a 15 mph crosswind. Not even considering other factors such as terrain and obstacles, a 15 mph crosswind would tend to move the helicopter sideways along the ground at 15 mph. Landing under these conditions would result in disastrously striking the ground were it not for the pilot noticing and correcting for the movement by providing the necessary control inputs. A trained pilot can accomplish this with relative ease, but for an unmanned, remotely controlled aircraft out of visible range of the remote operator and without the proper sensors to determine position and/or velocity, the task would be nearly impossible.

A common approach to control unmanned VTOL aircraft is to make the VTOL aircraft purely remote controlled from a position external to the aircraft. In this method, there is some form of pilot controls present on the ground for use by a remote operator. All piloting commands are then transmitted to the aircraft, and hence, the remote operator may control the aircraft directly from a remote location. The remote operator must have some direct sense of the aircraft, whether by a clear line-of-site visual, or by video monitors, sensors, or some combination thereof. By simply mounting one or more remotely viewable video cameras on the aircraft, it is possible for a remotely located human pilot to gain some sense of aircraft position and velocity. In any case, it is almost always necessary to have a direct-line-of site visual as well as close proximity during take-off and landing operations so that the pilot can gain direct visual cues from the aircraft apart from the video system. Thus, while this solution has been met with success in fixed-wing aircraft, the method has the drawback of requiring a high level of operator skill and intervention when applied to VTOL aircraft. It also requires that the flight of the aircraft be very far from the ground or any other obstacles except when the aircraft is near the pilot.

A second common approach used to control unmanned VTOL aircraft combines some of the techniques described above with on-board stability control systems and “auto-pilot” systems. It is common for these more advanced systems to use an Inertial Measurement Unit (IMU) to allow the aircraft to make small adjustments to maintain level flight and/or hover. Although this system does provide rotational sensory information, it does not give any translational information. Hence, the system will not account for the difference between a hovering aircraft and one that is flying at a high speed, since both aircraft may be level with respect to the earth. The result of this method is that the aircraft may be slightly easier to control than it would be using the first method, but essentially all the same drawbacks still apply.

A third common approach is similar to the second, only with the addition of onboard GPS capability to control the flight path of the aircraft. Typically an operator would program several waypoints into the aircraft flight computer. Then the computer would control the aircraft to fly the specified path. Typically this flight path would take place far from obstacles due to the low resolution of the system. A human pilot would typically be required for landings and take-offs, unless a very large open field was available and the aircraft was capable of handling less than smooth landings. With such a system, loitering near the ground, buildings, or other points of interest remotely is typically not a feasible option.

Thus, there is a need for a system that can sense the position and velocity of the aircraft relative to the Earth. Such a system is necessary to ensure the aircraft avoids obstacles, flies a predictable path, and successfully accomplishes take-offs and landings under less than ideal conditions.

### DESCRIPTION OF THE PRIOR ART AND OBJECTIVES OF THE INVENTION

Numerous technologies and advancements have been developed in an attempt to solve the above problems.

One such method commonly employed by current manufacturers of VTOL aircraft employs the use a stability control system. Generally the system employed is similar to the IMU system described above in the “Background of the Invention” portion of this application, in which an IMU is combined with a closed-loop control system. In many cases, these aircraft are inherently unstable to begin with, and adding the stability control system acts primarily to make the aircraft behave more like a traditional helicopter. Thus it becomes not much easier to pilot than a conventional helicopter. In other cases, when the aircraft is stable to begin with, adding the IMU will typically add the “auto-leveling” feature, but the control of the aircraft is still substantially the same and requires roughly the same level of skill from the operator.

Stability control systems do not make these aircraft “easy” to fly for the inexperienced pilot. This is because in these systems, even though the stability control system will keep the aircraft stable in the sense that it may not spontaneously flip upside down, the aircraft is still subject to a minimum of 3 axes of translation (up/down, left/right, forward/backward). The slightest input from the pilot or even the slightest wind can result in significant aircraft movement in all 3 axes simultaneously. In order to stop the motion and bring the aircraft under control, the operator must command a minimum of 3 axes of control simultaneously in a very quick manner. In fact, this pilot-response must be so fast that the pilot cannot stop to think about which control moves which axis, and instead must act instinctively. When the pilot is situated remotely, this difficulty is compounded as the pilot not only has less sensory information from which to work, but is also outside the aircraft which takes on various different orientations relative to the pilot. It is thus commonly known that learning just the basics of hovering a VTOL aircraft can take a great deal of time.

A newer design that solves some, but not all of the above problems is the HeliCommand system sold by the international model manufacturing company Robbe Schluter. Although complete documentation for the most advanced products has not been released, the documentation available at http://data.robbe-online.net/robbe_pdf/P1101/P1101_{—}1-8493.pdf does disclose the use of video processing and inertial meters to provide stability for VTOL aircraft. However, the documentation makes the point that, within the HeliCommand unit, the attitude leveling system is a distinctly separate, independent system from the video processing system. The documentation states that the two systems are so separate that it increases reliability, since the two systems operate independently and one could operate without the other in a case when one system fails. Thus, when using the vision system from the disclosed document, the aircraft must be operated in a constant-attitude manner in order to prevent the system from being confused by ambiguous video data that would result from rotational visual information being coupled with translational data. This is problematic because forward flight typically requires that changes in attitude be employed. Thus, the conditions for successful operation of the device are limited. Furthermore, if these limitations are exceeded, due to wind or another cause, the system may become unstable. In addition, it is clear that the system does not provide substantial stability over its visual range as the aircraft approaches or departs from the ground, since the vision system does not compensate for altitude. This is problematic because at low elevations, such as during landing, increased stability is critical. Additionally, the “position hold” capabilities of the system are not true position hold. Rather, they are built from an attempt to bring the velocity of the aircraft to zero rather than to hold the position of the aircraft constant. Thus, the system is inherently susceptible to translational drift. Thus, any move of the aircraft due to inaccuracies in calibration, noise in the sensors, or wind, will not be reversed by the system, and drift of the aircraft will occur. Rather than keeping the visual system separate from the attitude system (the HeliCommand approach), the approach disclosed herein by Applicant combines the two systems in a novel way so as to improve the performance, features, and the range of conditions under which the system will work reliably.

To help combat the translation problem described above, one solution is to gather position and velocity data from an onboard Global Positioning System (GPS), or other very specialized localization system. This works well in certain situations, most of which related to fixed-wing aircraft or high altitude control, where a high level of precision is not needed. However, for many other uses there are serious drawbacks.

First, GPS can suffer from lack of reception if weather, buildings, or geography separates the aircraft from some of the satellites on which GPS depends. During these conditions, GPS can be useless. Furthermore, lack of reception is most likely to happen at low altitudes during take-offs and landings, when precision is most needed. Hence, by its nature the use of GPS depends on complex external technical systems in order to function. The dependability of these external technological systems is questionable in a wartime environment and when the aircraft is operating in canyons, near buildings, and other areas where GPS reception is weak.

Another drawback to GPS based systems is that traditional GPS does not have the high resolution or update rate needed to provide enough localization to allow real-time control during take-offs and landings. In fact, even when differential GPS, such as Wide Area Augmentation System (WASS) differential is used, and is accurate to within 3 m, it is not precise enough to allow safe take-offs and landings. For take-offs and landings, typically the only GPS systems that are sufficient are those augmented by ground based localization beacons. These systems are expensive, and require the ground based beacon to be installed and running near the point of flight for the aircraft. The use of these beacons also adds an additional external technological dependency to the system, further reducing the reliability of the system. This ultimately makes both standard GPS and differential GPS inadequate to provide useful position and velocity information for many near-Earth applications.

Because of the aforementioned difficulties and other limitations, unmanned VTOL aircraft have typically been unpractical for many applications. In addition to the above difficulties and problems, many of the previous systems would be too large and heavy for application on micro UAVs, which may weigh under a pound.

It is thus an objective of the present invention to provide for a low mass, small sized completely autonomous unmanned VTOL aircraft system for determining position and velocity of the aircraft in a novel manner that is low-cost and independent of external technological dependencies.

It is a second objective of the invention to enable an aircraft to autonomously take-off and land and fly in close proximity to both moving and nonmoving objects without striking them.

It is a third objective of the invention to provide an autonomous aircraft with the ability to maintain zero translational drift in relation to a fixed or moving object.

It is a fourth objective of the invention to allow a remote pilot with little piloting experience to successfully remotely pilot a VTOL aircraft.

It is a fifth objective of the invention to provide a practical means of providing position and/or velocity data for direct use such as increased instrumentation on a manned or unmanned aircraft.]

### BRIEF DESCRIPTION OF THE FIGURES

FIG. 1 is an overview diagram of Applicant's aircraft position and velocity sense and control system according to a preferred embodiment of the present invention.

FIG. 2 is a graph depicting measured degrees of rotation by both a vision based system and an IMU based system.

FIG. 3 is an example control scheme for implementing a stability and positional control system for the pitch axis of a VTOL aircraft.

FIG. 4 is an example control scheme for implementing a stability and positional control system for the yaw axis of a VTOL aircraft.

FIG. 5 is an alternative means of controlling velocity of an aircraft.

FIG. 6 is a control loop assigning a weight to a couple methods of velocity control as a function of aircraft altitude.

### SUMMARY OF THE INVENTION

The invention is a system for determining the position and/or velocity of an autonomous aircraft in a low-cost, low-weight manner independent of external technological dependencies such as satellites or beacons. The solution comprises a combination of traditional technologies (IMUs, altitude sensing, control systems, visual sensing technology, etc.) coupled with algorithms to implement their combined use. The solution is small enough for inclusion on small mass aircraft, yet its precision and capability make it useful for large aircraft as well. Utilizing the system, an aircraft is able to autonomously take-off and land, station hold in a very precise manner, and fly in very close proximity to other objects with little chance of collision.

### DETAILED DESCRIPTION OF THE INVENTION

The Applicant's system and method for determining the position and velocity of an autonomous aircraft in a low-cost, low-weight manner independent of external technological dependencies mimics many of the inherent abilities of an experienced helicopter pilot. The flight abilities of the human brain can best be shown through an understanding of the processes that occur when an experienced helicopter pilot safely controls the speed, direction, roll, pitch and yaw of a helicopter during landing, even without access to any guiding instrumentation. In a typical instrument-free landing, the pilot would first maintain the aircraft in a relatively level manner by using his sense of equilibrium to know which way is right side up. He may then control the aircraft to maintain a fairly level state. He would also look outside the aircraft to gain an indication of how far away the aircraft is from the ground and to see how much and which direction the aircraft is moving relative to the ground. As the pilot lowers the aircraft to the ground, the pilot would fine-tune the control to make sure the aircraft is not moving laterally relative to the ground at the time of touchdown. Visual cues from nearly all the pilot's surroundings (buildings, trees, grass, etc.) guide the pilot as the pilot determines how these objects are moving relative to the aircraft.

The number of simultaneous operations and calculations easily performed by an experienced pilot were until now notoriously difficult to perform by a computer. Applicant thus discloses a system for determining the position and velocity of an autonomous aircraft in a low-cost, low-weight manner independent of external technological dependencies. The system combines some traditional technologies (IMUs, altitude sensing, control systems, etc.) in a novel way with visual sensing technology.

For purposes of this application and unless otherwise defined, yaw is the turning of an aircraft so as to change its heading, and roll and pitch angles describe the angle of the aircraft deviating from level relative to the horizon.

In summary, the system uses a high-speed vision sensing system (such as Complementary metal-oxide-semiconductor (CMOS) or a charge-coupled device (CCD) camera combined with a DSP or other computer and software) aimed toward the ground and/or the sides and/or the top of the aircraft. These systems are designed to observe the movement of the image in view. Thus, for example, if a VTOL aircraft were moving forward, then the system looking at the ground would “see” the ground moving rearward. In many applications, the data that such a system generates is typically referred to as Optic Flow. In a preferred embodiment of the present invention, Optic Flow data of the scenery and/or obstacles and/or objects in the field of view outside the aircraft are received. For use in this application, however, the data also could relate to only one or few objects that are being tracked by the vision system. For example, a soldier carrying an infrared light might shine the light for the optic system to track. The light would stand out to the camera system as one object among many. The vision system is able to detect this optic data, be it through optic flow or otherwise, and then taking into account elevation and angles of rotation of the aircraft is then able calculate both the velocity and/or relative position of the aircraft.

Utilizing pitch and roll data from an IMU or similar device, the CPU is able to distinguish movement along the plane of the ground with observed movement of the ground as the aircraft pitches and rolls. That is, during a change in pitch or during a roll, a screen showing an image pointing downward from an aircraft would appear to show objects on the ground moving across the screen. A simple vision system(s) would observe this movement in the images and “think” the aircraft has changed position and velocity when in fact the aircraft has merely began to pitch and/or roll. By utilizing the IMU data in conjunction with the observed image, the system is therefore able to completely discern movement on the screen due to angular changes of the aircraft from actual translational changes in the aircraft's position.

The invention utilizes the following subsystems:

1.) On-board IMU or similar device—This component is analogous to a human pilot's sense of equilibrium. An IMU is essentially a modern-day replacement for a mechanical spinning-mass vertical gyroscope, in that it is a closed system that may be used to detect attitude, motion, and sometimes some degree of location. It typically uses a combination of accelerometers and angular rate sensors, commonly comprising 3 accelerometers measuring 3 axes, and 3 axes of rate gyros mounted orthogonally. Software and an associated processor, typically employing Kalman filtering, then intelligently combine the acceleration and angular rate data to give pitch/roll attitude data that is referenced to gravity, yet is not subject to accelerations of the aircraft. Thus is formed an accurate pitch/roll attitude and heading data stream that is based purely on inertial measurement and does not rely on visual information, satellites, or any external technological dependencies.

IMU systems are well known in the art, and descriptions of several can be referenced in U.S. Pat. Nos. 4,675,820 to Smith et al., 4,711,125 to Morrison, 6,725,719 to Cardarelli, and 7,066,004 to Kohler et al. Similar data can also be achieved using other means such as an infrared horizon detector such as the Co-Pilot Flight Stabilization System, Part No. CPD4, from FMA Direct. The device uses infrared signatures in order to determine an aircraft's attitude in the pitch and roll axes. See. U.S. Pat. No. 6,181,989 to Gwozdecki. The device disclosed in Gwozdecki is a suitable replacement for the IMU in the present invention, although it does not provide accurate data under all conditions and thus may not be suitable for all situations. While other pitch and roll detection devices may be used, the effectiveness and reliability of an IMU system has prompted the Applicant to use this in a preferred embodiment of the invention.

2.) High-Speed Video Camera System—A special on-board high-speed video camera and video data processing system observes the view beneath the aircraft and towards the ground. Multiple cameras may be used either for redundancy or to point in directions different from the first camera. For example, a camera pointed out the front of the aircraft could be used to hover or fly the aircraft near a building in a precision manner relative to the building (such as hovering and staring in a window, or flying around the perimeter of the building). A camera looking down could be used to hover over the ground in a fixed location (even in the presence of wind), fly in a precision manner above the ground, or fly above a moving vehicle, tracking the motion of the vehicle. In any case, the camera system works by locating “landmarks” in the video image and tracking the landmarks as they move in the image. Analysis of the moving landmarks tells the CPU which direction the image is moving relative to the camera and hence which direction the aircraft is moving relative to the ground. This system is analogous to a pilot looking out the window of his aircraft.

The computer analysis and software used in conjunction with the above subsystems is discussed infra. With regard to the hardware, the video system can be implemented in various ways. In a preferred embodiment, a high-speed CMOS or CCD camera is connected to a high-speed signal-processing computer with adequate memory and processing capability. The software then processes each subsequent frame of the video sequence and performs mathematical operations according to the field of computer vision study, to obtain the movement vector of the image. This movement vector can be based upon one particular object in the frame, or upon multiple objects, or upon the majority of features within the frame. Frame rates of up to and beyond 3000 frames per second allow the system to accurately track any movement of the aircraft; even high speed forward flight or quick rotational changes. With enough resolution, the system is able to input tiny adjustments in the aircraft's position, making the aircraft appear to an outside observer to be absolutely still (in the case of a hover), or to carry on precision flight around obstacles. Multiple vision systems could be implemented together to provide redundancy to protect against the event the camera lens becomes dirty or the camera hardware fails.

In an alternative embodiment, the video capture device, processing unit and memory could all reside in the same package and even on the same piece of silicon, resulting in a very compact, lightweight, low-cost, highly-integrated solution. An example of where this has been accomplished is in the optical computer mouse industry where a similar system and image processor decodes consecutive images looking for movement vectors associated with the movement of a computer mouse. This is all done in real-time by hardware in a single chip.

3.) Altitude-Determining Means—There are many inexpensive means for determining the altitude of an aircraft and this system typically uses one of these means. Systems used may include but are not limited to active and passive altimeters such as laser, infrared, stereo vision, sonic range finders, and barometric pressure altimeters. These systems are akin to a human pilot looking out the window and observing that he is very high. They are also akin to a human pilot merely reading his own instruments to determine altitude. Similarly, additional distance-sensors and vision sensing systems (as described above) may point out the side of the aircraft to observe the movement of nearby objects to determine vertical and horizontal movement of the aircraft relative to a vertical object such as a building or hillside.

In Operation

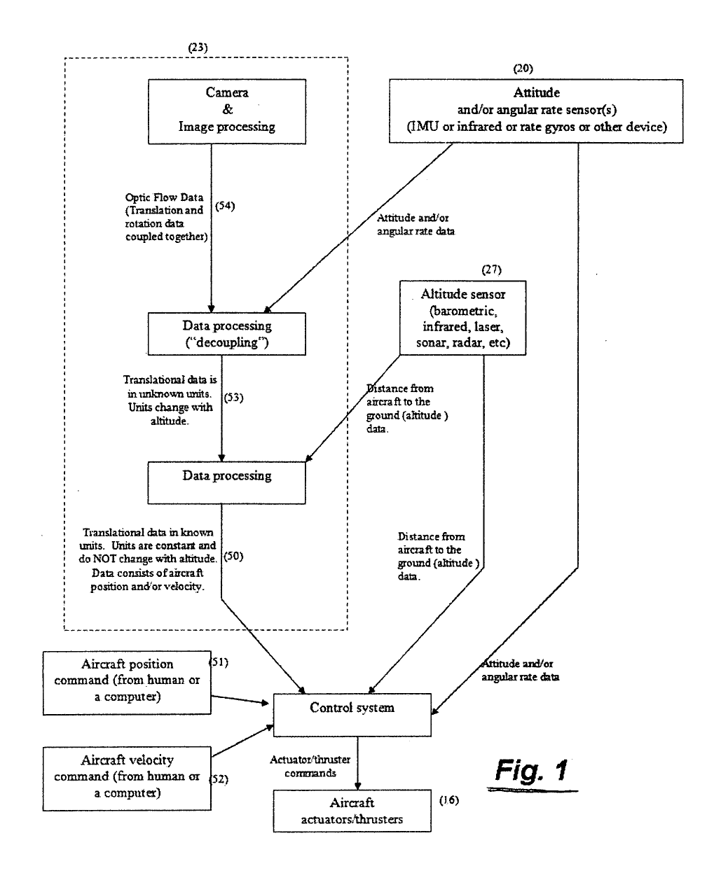

In summary, the data from all three subsystems are combined in a manner to produce position and/or velocity data. Once this data is known, it could be used for purposes such as instrumentation, flight data recording, and/or control of an aircraft. FIG. 1 provides a broad overview of the Applicant's system taking into account data received from each of the three subsystems described above. In FIG. 1, a translational sensor system 23 is a system for detecting position and/or velocity. Beginning with images captured by a camera system, optic flow or similar data 54, or similar data relating to the movement of one or more objects within the field of view of the vision system is gathered according to conventional methods well known in the art field. Since this data comprises both translational and rotation data coupled together, it must be decoupled through further data processing. This is accomplished using measurements from the IMU sensor system 20. As detailed throughout this patent application, the IMU is a preferred method of detecting attitude and/or angular rate, but other methods work as well. Attitude and/or angular rate data is processed with the optic flow or similar data 54 to generate translational data 53. Because the magnitude of this data is a function of altitude, the units of this data change with altitude.

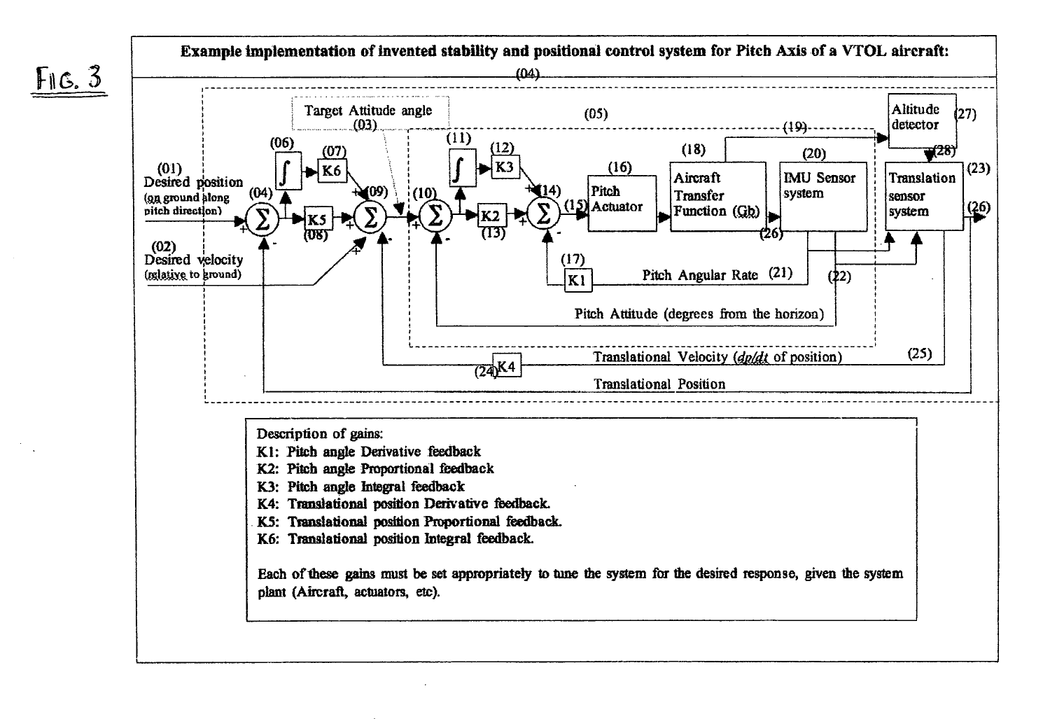

To put the translational data 53 into known units, altitude sensor data 27 must be gathered and utilized to process translational data 53. After processing, the aircraft position and/or velocity data 50 is known. These data are in known units, are constant, and are now known independently of altitude data, and are ready to be fed into Applicant's control system, described later in text accompanying FIGS. 3-6, or to be used in another manner such as instrumentation. Fed into this control system is aircraft position and/or velocity data 50, aircraft position command data 51 from a human or another computer, aircraft velocity command data 52 from a human or another computer, data from the altitude detector 27, and data from the attitude and/or angular rate sensor 20. Reference numbers 51 and 52 summarize two potential command inputs into the control system. Depending on how the control system is set up, either one or both of these inputs may be used. The details of this control system are described later in this application. From the control system a series of actuator and thruster commands are generated in order to cause the aircraft to optimally perform the movements commanded by the control system. The aircraft pitch actuator 16 is controlled accordingly.

The decoupling process referenced above will now be described in detail. First, optic flow or similar data 54 is pulled from the video data according to conventional optic flow and/or object tracking methods. Next, data regarding attitude and/or aircraft angular rate is inputted and optic flow or similar data 54 corresponding to these movements is compensated for. For instance, if the aircraft is detected to have rolled clockwise 1.25 degrees, than 1.25 degrees is accounted for by subtraction during the data decoupling process. Once this amount is subtracted out, motions detected on the video are now as a result only of a change in the aircraft's position and any ambiguities have been removed. Hence, by tightly integrating the optical data with the attitude and/or angular rate data, the aircraft's position can be determined. Once position is determined, aircraft velocity can be determined by taking the time derivative of the position.

The processing associated with the video system will be described first. It should be noted that there is an already established field of study within the computer vision community of object tracking within an image using computational methods. See U.S. Pat. Nos. 4,794,384 to Jackson, 6,384,905 to Barrows, 6,433,780 to Gordon et al., and 6,507,661 to Roy. In a preferred embodiment, Applicant's vision system is comparable to optic flow in humans. That is, the perceived visual motion of objects as an observer moves relative to those objects allows the observer to judge how close he is to certain objects and his movement relative to them. For instance, to an observer, an object slowly growing larger and larger, but not moving to one side of the observer's vision could be understood by the observer to be moving directly towards the observer. In the present invention, it is often preferred to have the CPU track all “objects” or landmarks within a video image. They should all move with approximately the same vector (speed and direction) when the camera is pointed toward the ground and the landmarks within the image are all on the ground. A correlation between the movements of the landmarks within the image is detected by a processor. The algorithm could reject (ignore) any landmarks that do not fit the correlation, such as a bird flying closely under the aircraft. Performing the above optic flow measurements is well known in the art, and various software methods could be used to determine the relative movement as detected by the camera. In addition, various software methods can provide varying degrees of robustness and rejection of false movements. In a similar embodiment, the Applicant's vision system has the capability of tracking one or more particular objects within the field of vision, according to known object tracking methods.

The system may employ feature selection, an already well established means of object tracking whereby the best features from a contrast properties perspective are tracked. There is no need for the imaging system to correctly identify and label objects such as trees or cars or painted lines on the ground. The system merely has to know the object observed (in the case of a tree, a tall green object) is something to be tracked through subsequent image frames. Knowing the identity of the object is not necessary to understand the aircraft movement relative to the object. This feature is important because it allows the invention to be implemented using typical inexpensive processors and computer power currently available. It also means that the terrain below the aircraft and the obstacles near an aircraft do not have to be known or defined in advance. In an alternative embodiment, the system may identify and track one or more recognizable objects if it were desirable for the aircraft to move relative to specific object(s) within the vision system's field of view.

The above steps merely determine the movement vector of an image in the video sequence analyzed by the system. From this, the computer still cannot determine the amount, if any, of translational movement of the aircraft. This is due to several complications that are also solved by Applicant's system. The complications and solution for each are described:

1.) Rotational movement of the aircraft results in a similar video sequence as translational movement—Thus, trying to fly the aircraft purely by the visual data steam would result in flight decisions being made on ambiguous data, which would likely prove disastrous if the aircraft encounters any substantial attitude change during the flight. However, by de-coupling the rotational movement from the translational movement in the video sequence, the ambiguous data becomes certain. The de-coupling occurs by using a properly tuned IMU. An ideal IMU outputs a data stream of accurate pitch/roll attitude and yaw readings that is based purely on inertial measurements, not relying on visual information, satellites, or any external technological dependencies. IMUs capable of this are well known. The data stream outputted from the IMU is used to determine how much of the movement observed in the video sequence is due to rotational aircraft changes (attitude change) versus how much of the movement is due to translational (i.e. position) change.

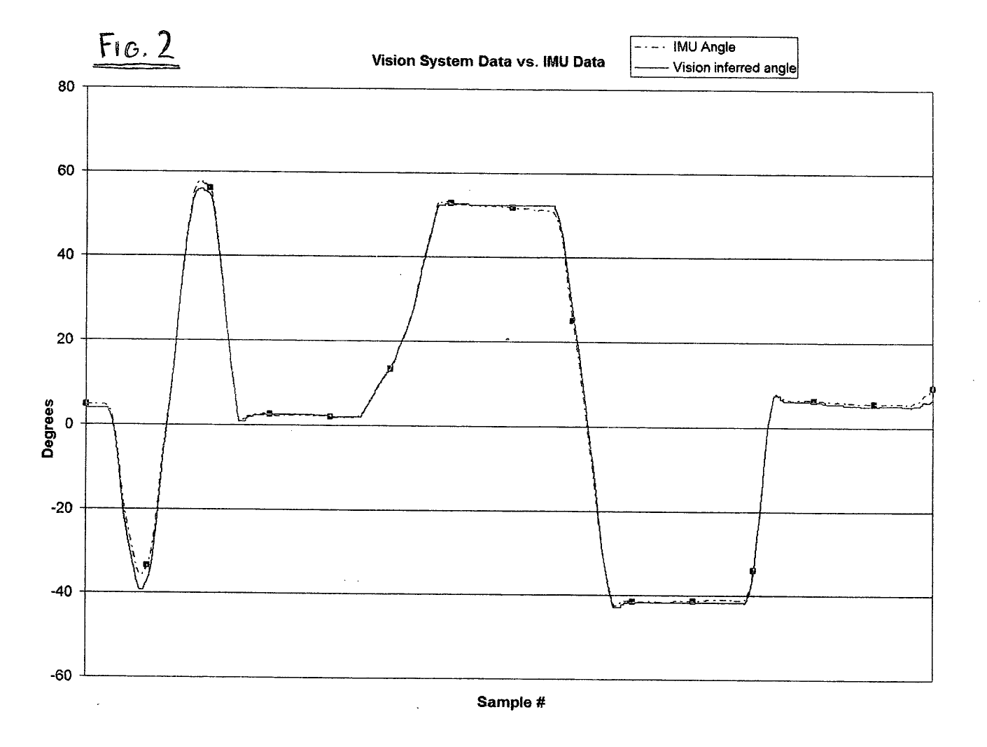

It is important during all of this for both systems to be accurate. FIG. 2 is a plot showing a very strong correlation between degrees of rotation detected from an IMU system and degrees of rotation detected from the vision system (in this case the vision system was constrained in position relative to the Earth to give only rotational output). The data in FIG. 2 was obtained with test hardware being rolled back and forth on an axis 5 feet off the ground. The degree of rotation detected by both the IMU and the vision system constitutes the Y-axis and the sample number constitutes the X-axis. As thousands of samples are taken every second, just a few seconds of data results in many thousands of data points. The two graphs show independent measurements taken from the IMU and the vision system. For this test the computer in both cases assumed that 100% of the movement was rotational. As shown in FIG. 2, the two systems are in agreement and are accurate. In actual use, these signals will be subtracted from each other to remove the rotational component from the visual signal and thus obtain translational position. As shown in the test case in FIG. 2, subtracting the one signal from the other here results in zero translational movement, as expected.

Although the test described above and by FIG. 2 was performed at a height of 5 feet, one should note that regardless of the altitude of an aircraft equipped with this system, rotational movements would appear similarly in the video sequence. This is because the camera is being swept a certain amount of degrees per second over the landscape. Thus, the video sequence can be de-coupled by taking the pitch/roll attitude of the aircraft, multiplying this by a factor to equalize pitch/roll data and video data, and then subtracting from this amount the perceived displacement of the camera from the video sequence. Finally, unless otherwise specified, the equations in this application relate only to one axis for simplicity; that is, they relate only to either pitch or roll, or yaw. In actual use the same process and equations described above would occur twice—once for each of both the X axis and the Y axis, or three times if the Z axis position and/or velocity were controlled as well. For example, if the equations are applied once to adjust for an aircraft's pitch, in an actual system they may also be applied to the aircraft's roll, and/or the aircraft's collective to control up and down movement.

Typically the positions and or velocities would be constantly updated by repeatedly re-calculating them, with a short time (Δt) in-between each set of calculations. Utilizing the absolute angles determined by the IMU, at each time step, the change in position may be calculated as shown below. Given a small change in time (Δt) between a given time step (subscript k) and the previous time step (subscript k−1), each time step being when a set of such calculations are performed. The calculation for finding position(s) if absolute angles are known is as follows:
Xₖ=Xₖ₋₁+[Δmₒ−(θₖ−θₖ₋₁)·Cᵣ]·Cₐ·z

The calculation for finding velocity(ies) if absolute angles are known is as follows:

$${V}_{k} = \frac{[ Δ {m}_{o} - ( {θ}_{k} - {θ}_{k - 1} ) \cdot {C}_{r} ] \cdot {C}_{a} \cdot z}{Δ t}$$

An alternative method for de-coupling the data allows for another method to be used whereby one or more rate gyros are used in place of an IMU. The Earth's acceleration (and hence absolute attitude and gravity reference) is not needed in this alternative method. Thus a full IMU is not required in this alternative method. The calculation for finding position(s) if angular rate(s) are known is as follows:
Xₖ=Xₖ₋₁+[Δmₒ−·Δt·Cᵣ]·Cₐz

The calculation for finding velocity(ies) if angular rate(s) are known is as follows:

$${V}_{k} = \frac{[ Δ {m}_{o} - ϖ \cdot Δ t \cdot {C}_{r} ] \cdot {C}_{a} \cdot z}{Δ t}$$

Where X is the position of aircraft relative to the Earth (or other object being tracked), θ is the angle of the aircraft relative to the horizon in the axis of interest. [symbol] is the angular velocity, in the axis of interest (such as the output of an angular rate gyro). Δmₒ is the amount of observed movement (typically in pixels) given by the vision subsystem during the time period in question (Δt), z is the distance between aircraft and the object scenery being observed by the vision system (often the ground, but may often be the side of buildings, hills, a tracked object, etc). V is the velocity of the aircraft relative to the Earth (or other object being tracked). Cᵣ and Cₐ are constants which capture the mathematical essence of the specific hardware used. The same constants apply to all of the above equations. These constants typically only need to be computed once when the system is designed or tested, or when components such as lens or camera are changed. They may be computed using the following equations:

$${C}_{r} = \frac{Δ {m}_{o}}{Δ θ}$$

when ΔX=0 (Hold the position of the aircraft constant and rotate it about the given axis. And observe what the vision system output Δmₒ is. Then compute Cᵣ.)

$${C}_{a} = \frac{Δ X}{Δ {m}_{o} \cdot z}$$

when Δθ=0 and Δz=0 (Hold the aircraft's angle and altitude constant, and move its position and observe what vision system output Δmₒ is. Then compute Cₐ.)

For the above equations and other equations in this application θ, unless otherwise specified is the absolute Earth-Frame “Artificial Horizon” angle in either the pitch or roll axis. X and mₒ are in the axis from rear to front of aircraft, when θ is chosen as pitch, and X and mₒ are in the axis from left to right, when θ is chosen as roll. If it is desired to know the absolute position relative to a point on Earth after yaw movements, then trigonometric equations may be added to translate the movements into an Earth reference frame coordinate system.

By transposing the axis of each of the variables, the above equations can be applied to a vision system pointing out to the left of the aircraft, for example, pointing at the side of a building and being used to hold position of the aircraft and/or supply position and/or velocity data of aircraft relative to the building.

In the above equations, the altitude of the aircraft (z) is used to provide robust position and/or velocity data, where the scale is known and constant. While this is the preferred method, in certain cases, it may be possible to omit or set z to a constant to reduce the number of required sensors and in general simplify the hardware.

2.) Translational movement of the aircraft results in a different video sequence depending on the distance of the object from the camera. For purposes of this section, object shall refer to the ground, although in general the principles apply whether the object is in fact a street, the top of a building, or for instance the top of a moving object such as a truck or train. It is desirable for the system to accommodate for the fact that at higher altitudes, the translational movement of objects across a screen showing a video image looking down from the aircraft slows down. This effect can be easily understood by comparing the view downwards from a passenger airplane at take-off, and the view looking down from 7 miles up. Although the speed of the aircraft is generally much greater at high altitude, it appears to the passenger to be moving slowly because of the height at which ground-based objects are observed.

In Applicant's system the above is compensated for by applying a gain factor to the translational movement detected by the video/IMU system, where the gain applied is proportional to the distance between the camera and the object. The equations above show a specific way of implementing this gain. Since generally the object viewed by the camera is the ground, the gain is generally proportional to aircraft altitude. As noted previously there are several ways common in the art to measure altitude, each with different advantages and disadvantages. For this reason it may often be practical to use several different types of sensors and to combine the data to obtain an improved estimate of actual altitude. In the process of doing this, it must be recognized that different methods may give different results if the aircraft is not level. For example, a laser altimeter which projects a beam downwards from the bottom of an aircraft and then calculates height based on the time needed for the beam to reflect back can give erroneous data is the aircraft is rolled to one side. For instance, if the aircraft is at a 45-degree angle then the laser may record the time of reflection for a point away in the distance at a 45-degree angle relative to straight down. This distance observed by the laser in this case will most likely be approximately 2√2 times the actual height of the aircraft. This can be accounted for using trigonometry and the pitch/roll attitude determined by the onboard IMU. Once the actual altitude of the aircraft is known, and the angle between the camera and the ground is known (from IMU data), the distance to the center of field of vision can be calculated using basic trigonometry.

In a similar manner, a forward or side-looking camera system could use forward or side-looking sensors to determine the distance from the camera to the object being seen by the camera. Examples of such sensors include but are not limited to radar, laser range finding, stereo vision, and sonar. If such sensors are not employed, the invention will still provide position and velocity information, albeit in unknown units.

3.) The higher the altitude, the less precise the vision system. Altitude and precision are inversely proportional in the present invention. Eventually, at a high enough altitude, the Applicant's disclosed vision system's usefulness decreases to a point where GPS is the more useful (or in some cases most useful) means of determining position. This, however, is acceptable because positional accuracy matters less at these high altitudes. There are typically no obstacles at such high altitudes, landings by definition cannot occur at high altitude, and there is typically less need to have knowledge of the aircraft's precise location. In short, at higher altitudes, as long as the aircraft is in the general area where it is expected to be, nothing more is needed. As an aircraft utilizing Applicant's system approaches the ground, the resolution of the ground observed by the video system increases, and it is at these lower altitudes where a very high positional accuracy is needed. Furthermore, GPS tends to be more reliable at higher altitudes, as again there are no obstructions from objects. Thus, if high altitude precision is desired, a GPS receiver may be added to the system to augments its capabilities.

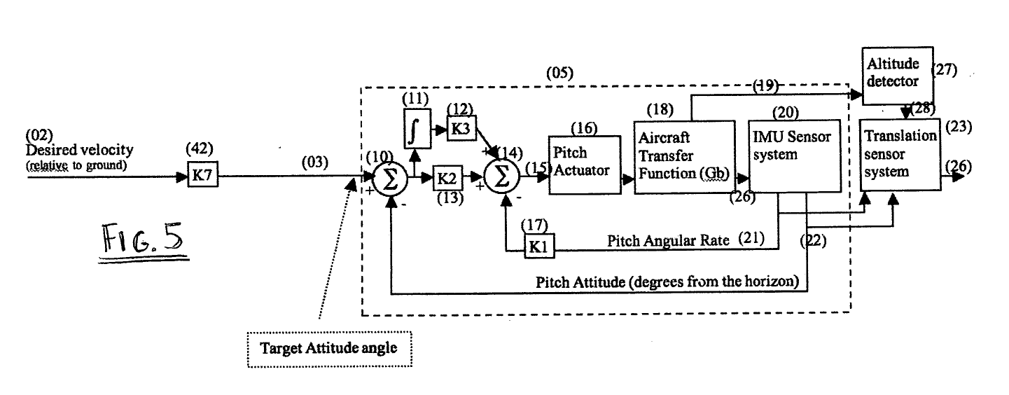

There may be certain conditions under which the data coming from the vision system is untrustworthy, such as when there are not enough scenery features of high enough quality to track. In such a case, the vision system can flag this condition so that any instruments or control loops will know to ignore the data and operate without it. Recognizing and flagging such a condition can be accomplished in any number of ways by one skilled in the art. For example, the image can be analyzed and threshold(s) set for number of features or contrast of features, degree of light, etc. Upon receiving the indication that the vision data is untrustworthy, the control system can ignore it by disabling the vision-based position and velocity control portion of the control loops, but still utilizing the other sensors and control loop elements, for example as depicted in FIG. 5. Thus, by avoiding the situation where the system acts as though the data is good when in reality it is not, the possibly of crashing the aircraft due to poor visual conditions is greatly reduced.

Once the system has properly decoded the true rotational orientations and translational movements of the aircraft, these data may be used by the system to intelligently control the aircraft. Before any changes to the flight actuators are made, processing of the data in an angle control loop occurs. A control system similar to that shown in FIG. 3 can provide this.

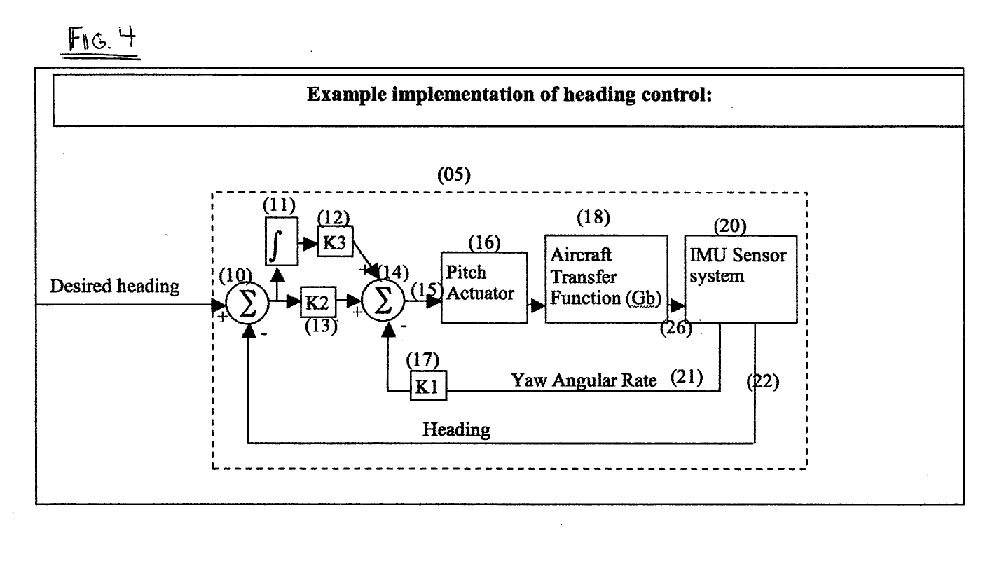

FIG. 3 is an example control scheme for implementing a stability and positional control system for the pitch axis of a VTOL aircraft. The control loop shown in FIG. 3 must be repeated for the roll axis. To control the third axis, yaw, a similar control scheme can be used except that translational sensing is not necessary, so the outer translational control loops may be omitted, as shown in FIG. 4.

Still referring to FIG. 3, the following discussion again for simplicity only follows pitch control. It is again noted that the processing is repeated again for roll, and in a simplified form for yaw. It could also be repeated to control collective, resulting in control of vertical movement of the aircraft, if one or more vision systems are pointed out one of the sides of the aircraft. In a preferred embodiment, the default velocity for the craft when there is no control will be 0 relative to the “ground” or in the case of tracking, 0 relative to the velocity of the object being tracked. As indicated above, “ground” may be loosely defined as an object near the aircraft that is being tracked, such as the grass on the ground or the rooftop or side of a building. Any time a desired velocity other than 0 is entered into the system, the system can be set up to have “desired position” continuously set to current position, and while the position integrator is reset. In this sense the craft has control over its velocity, or in the case of remote operation, the remote operator has control over the velocity. As soon as control ceases, or in the case of remote operation as soon as the operator lets go of the control, the system reverts back to position control, wherein it sets desired velocity to 0, and keeps desired position constant so as to let the system maintain that position, i.e. hover.

In FIG. 3, a positive pitch attitude is defined as the angle of the aircraft relative to the ground, hence the aircraft will tend fly in the positive Y direction. Likewise, a positive bank/roll is defined as an angle of the aircraft relative to the ground which would tend to make the aircraft move in the positive X direction. Generally, FIG. 3 describes a control system to control angle and angular rate in the pitch axis as well as translational position and velocity in the Y direction. As mentioned above, in practice the same control system would also control the angle and angular rate in the roll axis and translational position and velocity in the X direction.

Blocks 16 and 18 together compose an aircraft's “plant”; a system that has a means of producing lift and producing thrust in various directions. Block 16 represents the pitch actuator and block 18 represents and the aircraft transfer function. Because all the forces necessary to maintain control of an aircraft must be applied irrespective of the type of aircraft, any number of aircraft types may utilize the Applicant's stability scheme. As stated above, the aircraft may be anything from a traditional rotary-wing helicopter to something more exotic, such as a ducted-fan aircraft, multi-rotor aircraft, or any other aircraft that can lift its own weight and provide a mechanism to direct its thrust. This aircraft has an input 15, which directs the thrust in the direction that affects pitch of the aircraft. The output of the aircraft is a complex physical position and movement in the air represented by 26 (pitch angle and angular rate) and 19 (physical location and velocity of the aircraft relative to the Earth along the aircrafts' Y-axis).

An IMU 20 detects an aircraft pitch attitude angle 22 and an aircraft angular rate 21. An altitude detector 27 outputs altitude data 28. The translational sensor system 23 is the position and velocity detection system described earlier. Translational sensor system 23 takes data from angular rate 21 and pitch attitude angle 22 along with data from 19 (physical location and velocity of the aircraft relative to the Earth along the aircrafts' Y-axis) and altitude data 28 to obtain the aircraft Y-axis position 26 and/or aircraft velocity 25 data.

The control loop shown in FIG. 3 is essentially a cascaded system whereby an outer control loop 4 controls an inner control loop 5. The inner control loop 5 takes as its inputs the pitch attitude angle 22, the angular rate 21, and a target altitude angle 3. Inner control loop 5 then uses PID-type control elements (10, 11, 12, 13, 14, 17, and 24) to create a pitch actuator command 15 that drives the pitch actuator 16 of the aircraft to achieve target attitude angle 3.

Outer control loop 4 takes as its input the desired position 1 of the aircraft relative to the ground, the desired velocity 2 of the aircraft relative to the ground, aircraft velocity 25, and aircraft Y-axis position 26. It uses PID-type control elements (04, 06, 07, 08, 09, and 24) to produce target attitude angle 3. Thus a target attitude angle is produced from inputs of desired position, desired velocity, actual position, and actual velocity using Proportional Integral Derivative (PID) control techniques commonly known in the art of control systems. The Gains 08, 07, and 24 provide the gains for proportional, integral, and derivative, respectively.

Elements of the control scheme shown in FIG. 3 could be modified slightly and not depart from the spirit of the invention. For instance, the integral 6 and gain terms 7 could be moved to after the summation 9 instead of before it, and the system would still be functional. Similarly, the integral 11 and gain terms 12 could be moved to after the summation 14 instead of before it. In fact, the gains and feedback terms could be arranged in several combinations to produce a working equation. Furthermore, all the control elements could be carefully re-arranged to produce a single large control-loop that is mathematically similar and basically equivalent to this system. It is to be realized that such variations are deemed apparent to one skilled in the art and such variations are intended to be encompassed by the present invention. It is to be understood that displaying it in the format shown in the Figures enclosed herein offers a cleaner, more elegant view of the system, and it facilitates ease of understanding.

The control diagrams presented offer the options of using position and/or velocity control. Under position control, the control loop works to maintain a constant position. For example, if the aircraft is told to hover at a particular point over the ground, it will work to stay there. If some large outside force overpowers the aircraft and forces the aircraft away from its target point and then the force is released, the control system will bring the aircraft back to the original hover point. If an outside force is applied (such as wind) that cannot overpower the aircraft, the control system will overcome the force and hold the aircraft to a position above the hover point. With velocity control, the aircraft can be commanded, for example, to move forward at 15 knots. If an outside force such as wind slows or accelerates the aircraft, the control system will attempt to overcome the force and maintain a constant 15 knots. If commanded to hold the aircraft velocity at zero, the system will effectively allow the aircraft to hover, that is, move at a speed of zero. Unlike position control, if a wind or outside force moves the aircraft, the control system will attempt to resist the force but it will typically not oppose it completely, and if the force is removed, the aircraft will not move back to its original location. This is because the system is only attempting to maintain velocity at zero, and is not noting the position of the aircraft. Thus, in velocity control mode, the aircraft will inherently suffer from drift.

In practice, the system may be set to slow to a position hovering over a fixed point, rather than abruptly stopping at a fixed point. Because of inertial forces involved in coming to a hover from a high rate of speed, focusing on a position at which to maintain before the craft has come to a complete stop can prompt a series of overcorrections as the aircraft narrows in on its desired position. To prevent this problem from occurring, in an alternative embodiment the craft can be directed to first stop, then to maintain position.

To control altitude, the system is dependent on obtaining accurate altitude information from sensors. While this can be accomplished using one sensor, it can best be accomplished using several complementary sensors combined with an intelligent method to give an accurate estimate of altitude. There are various and known methods of determining altitude and many conventional systems readily available can be integrated in as one subsystem of the present invention.

Because altitude sensing is critical for optimal operation, redundant sensors may be used and their readings combined or used to calibrate each other in real-time. For close distances and very low altitudes, sonar altitude detection is a low-cost method to detect height above the ground. If for instance, it is detected that the ground material is too sonically absorbent, or there is too much thrust washout, the sonar may not work properly and in these causes data from an infrared distance sensor, laser rangefinder, etc. may be used. In situations where one of these sensors fails, one of the other sensors would still be working, providing at least one valid sensor reading at all times. In order to determine which sensor to rely upon at any given moment, the fact that altitude sensors fail in a predicable way can be exploited. Typically, the “failure” of any given sensor occurs when the transmitted beam (light, sounds, etc) reflection is never detected. Therefore, if a sensor never receives a reflected signal, the system infers that either (a) the ground is out of range and therefore very far away, or (b) conditions have made the reading unreliable. If one or more other sensors do obtain a reading, then it can be inferred that the first sensor did not get a reading due to reason (b), and therefore the sensor that does return a reading may be relied upon.

If the aircraft is at such a great altitude that the reflective based sensing systems (sonar, infrared, laser) do not detect a reflected signal, then other methods such as barometric pressure sensing may be implemented.

Once reliable altitude information is obtained, a control system will then accordingly command collective pitch and/or engine power (or other means dependent on the particular type of aircraft) to maintain a constant altitude. When sensor readings are fast, precise, and reliable, a common PID (Proportional-Integral-Derivative) feedback loop may be used. This would be particularly useful at low altitudes where the ground is sensed accurately and where precise altitude control is necessary. When the altitude information is not accurate or fast, a simpler control loop such as PI (Proportional-integral) loop may be used. Adaptive, non-linear or other control loops may also be used.

Once the above problems have been solved, a remote operator may input the directions to the aircraft which then autonomously implements them. Directions may also be applied by an internal computer, an external computer, or by artificial intelligence either on-board or external. When “piloted” by an external pilot, the remote operator may believe he or she is controlling a tiny inherently unstable aircraft over a computer monitor, when in fact the remote operator is merely inputting control directions that are subsequently executed by the autonomous aircraft. The system allows remote operators with no flight experience to control a craft that ordinarily would be remotely uncontrollable by even the most experienced pilots. The training time saved can be spent training a new operator on safety, policy procedures, and other peripheral issues important to safe and proper flight.

A typical landing procedure in a VTOL aircraft utilizing the above-described system would occur as follows: First, it is assumed that for ordinary landings (or take-offs) it would be desirable for the aircraft to maintain a fixed position over the ground while the aircraft descends (or rises). The on-board IMU senses inertial movements and commands the aircraft's controls to keep the aircraft fairly level. The video camera system and sensor observes the ground, detecting motion along the ground plane in at least two dimensions. The altitude detector 27 determines the aircraft's altitude. To keep the aircraft in a fixed position over the ground while the aircraft rises or descends, the control system (see FIG. 3) runs in a position control mode wherein desired velocity 2 is set to zero, and desired position 1 is set to the current XY position of the aircraft at the time a command is received to land. In this mode, the control loop works to maintain the aircraft in a fixed position, commanding the aircraft to counteract any observed translational motion.

Next, the aircraft's altitude is slowly lowered, either by an onboard program, artificial intelligence or a command from a ground based operator. Using its altimeter system, it can achieve a very smooth landing where it slows down more and more as it comes closer to the ground, until it just touches the ground softly. As the aircraft approaches the ground, the video camera system becomes inherently more accurate, so the closer the aircraft is to the ground, the more accurately it will hold a very tight, precise hover. The three subsystems working together allow the aircraft to touch down with relatively little lateral movement with respect to the ground.

It is noted that during the take-off or landing of an aircraft equipped with Applicant's system, an operator can control the craft using only one input—that is where to take-off from and where to land. The autonomous control system is able to complete all other procedures. Alternatively, a land-based operator could view a screen showing the image from the aircraft's on board video system and make control adjustments on the fly using a joystick or other type of input device. Although the remote operator can generally direct the flight path of the aircraft, all stabilization and wind correction adjustments are controlled autonomously.

Although hovering and landing has been described in detail, take-offs and other flight patterns such as forward flight and turning are also easily achieved. In flight, the aircraft can be commanded to move either by a ground-based operator, a pre-programmed script stored in memory on the aircraft itself, or by GPS coordinates either entered remotely or stored in the aircraft. The aircraft could also be commanded to move to track a ground-based object such as a truck or train.

For forward flight, the preferred method to achieve movement of the aircraft is to disable the position control loop and simply set desired velocity 02 to the velocity at which the operator or intelligent control entity (computer) wishes the aircraft to fly at. Thus the control loop elements 25,24,09, and 02 would form a closed-loop control of the aircrafts velocity. Optionally, elements 06 and 07 could be used as well if they are moved to the right of 09.

When stationary (hover) flight is desired, the position control loop would be re-enabled and allow the aircraft to precisely hold the given position in a drift-free manner. When in position hold mode, the system can allow an aircraft to maintain a position over a fixed point on the earth, even when a force strong enough to overpower the aircraft temporarily moves it away from its position over the fixed point. This strong force will typically be the wind, but could be as simple as a human pulling the hovering craft away from its target location. Once the force is removed, the system will automatically direct the aircraft back to its position over the fixed-point target. For reference, if an aircraft employing the applicant's system is hovering directly over a target at an altitude of 4 feet, and is moved out of position to a location directly above a point on the earth 10 feet away from the target, the system can return the aircraft to within plus or minus 0.5 feet of the original target position. This demonstrates the ability of the system to actively hold the aircraft over a target. In actual use, the force imposed by the wind is not strong enough to overpower the aircraft being actively controlled to oppose the wind. Therefore, any attempt on the wind's behalf to move the aircraft would immediately be met by a large resistance and the aircraft would not deviate substantially from the target position to begin with. In the event a large gust of wind did cause a significant deviation from the target position, the control system would immediately return the aircraft to the original position so that the error from multiple gusts of wind would not accumulate over time.

An alternative method to achieve movement of the aircraft would be to continuously re-adjust the desired position 1 so it is constantly reset to a position just forward of the actual position of the aircraft. See FIG. 3. In this manner the aircraft would continue to move forward, continuously trying to achieve a position just forward of its current position. By adjusting how far forward the desired position is set, the forward speed of the aircraft can thusly be precisely controlled. The same could be achieved for backwards or side-to-side flight by adjusting the corresponding variable in the applicable control loop.

An alternative method for forward flight would be to disable the position control loop and the velocity control loop completely and simply set target attitude angle 3 to a suitable angle. See FIG. 5. The greater the angle of the aircraft, the more thrust diverted laterally and therefore the more force is placed on the aircraft to move laterally. Using this method the computer may simply take the desired velocity 2 and multiply it by a constant gain factor 42 to determine a Target Attitude Angle 3. Although this method will not achieve the same level of precision flight as the aforementioned methods, it does have one advantage in that it does not depend on the translation sensor system. Thus it can be used at high altitudes where the translational system is operating at very low resolution.

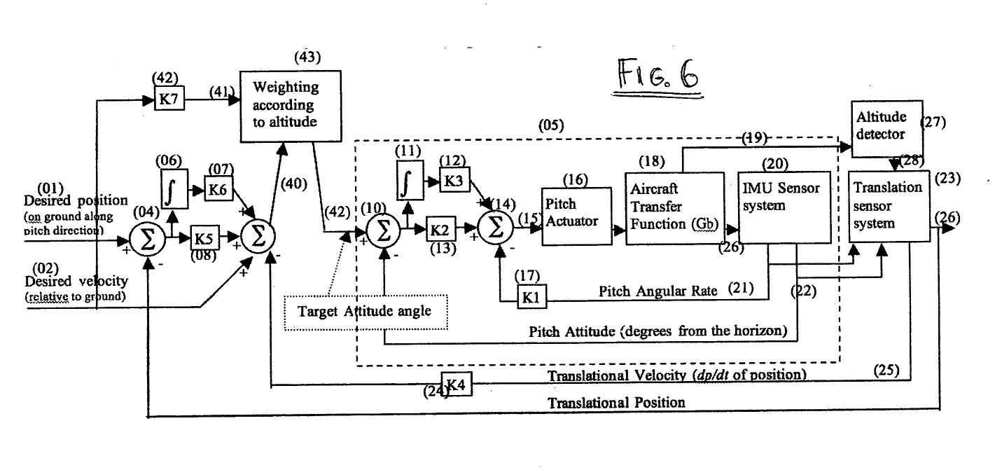

To provide smooth, controlled forward flight at all altitudes ranging from extremely close to the ground to many thousands of feet high, the control loop depicted in FIG. 6 may be used. Here, at all altitudes, outer control loop 4 computes a first target attitude angle 40. However, here the first target attitude angle 40 is further processed before being sent to inner control loop 5. Before that processing, however, a second target attitude angle 41 is computed directly from the desired velocity by applying gain factor 42 as explained above. This action occurs simultaneously to the computation of first target attitude angle 40. Now that the system has determined two different versions of the Target Attitude Angle (reference numbers 40 and 41) using two different methods, it applies a weighting 43 according to altitude to each target attitude angle and then combines the two to form a final target attitude angle 42, which is then applied to the inner control loop 5.

Weighting 43 will be chosen according to the altitude of the aircraft. At very low altitudes the weighting will be 100% in favor of the translation-sensor derived variable and 0% in favor of the simple operator-derived variable. As the altitude above ground level increases, the weighting will shift in favor of the simply derived variable until eventually the weighting is 0% in favor of the translation-sensor derived variable and 100% in favor of the simple operator-derived variable. This shift will be completed around the altitude at which the translation-sensor system has lost all its useful precision and no longer has anything of significant value to contribute to the control. Using this method will allow a very seamless control feel to an operator, where the aircraft will seem to respond to his commands in a similar fashion at all altitudes. Yet at lower altitudes (near the ground and other objects), it will also provide great resistance to wind and provide a high degree of precision maneuverability around obstacles and relative to the Earth. At higher altitudes, it will not provide as much resistance to the wind. However, this will not matter much since the aircraft will not be near obstacles to collide with, and the operator will typically not even notice slight shifts of the aircraft due to wind.

Referring again to FIGS. 3-6, it is assumed that the aircraft has some “pitch” input which will cause the aircraft to experience a pitching motion according to the input. Once the aircraft has a pitch other than zero, in a preferred embodiment some of the main thrust will be directed laterally, which will cause the aircraft to move forward or backwards. This can be envisioned by considering a helicopter and how it typically leans (pitches) forward just prior to and during forward flight. Similarly, it is assumed there is a “bank” input that causes the aircraft to bank and subsequently move in that direction. Thus, lateral movement is accomplished by tilting the aircraft. In the case of a traditional helicopter, the swashplate is a mechanical component used to link controls to the moving main rotor blade. Typically, by tilting this plate forward, the aircraft will tend to pitch forward and vise versa. By tilting the plate to the left, the aircraft will tend to tilt to the left, and vise versa. So for a traditional helicopter, an actuator such as a servo, or a hydraulic or pneumatic cylinder, may be used to control the position of the swashplate. Thus, a pitch or roll command from the Applicant's control system would cause the swashplate to tilt accordingly, and thus cause the aircraft to tilt and move accordingly. The sensors described by the system then pick up this movement, and the control system adjusts its pitch and/or roll commands to accomplish the desired movement.

In a VTOL aircraft implementation, the aircraft could potentially be of a design where pitch and/or bank is not what necessarily moves the aircraft laterally. For example, the aircraft could remain substantially level at all times with respect to the Earth, and thrust could be vectored laterally to cause lateral motion. In these cases, the Applicant's cascading control scheme still applies. For instance, a positive bank command from the control system would tell the left thruster to increase power. This increased thrust to the left would cause the aircraft to move towards the right, essentially causing a similar lateral movement to the same command as in the traditional helicopter example. The pitch could work in a similar manner.

Alternatively, a VTOL aircraft could be designed which has essentially the same rotation and translation characteristics as the traditional helicopter described earlier, except with a different thrust mechanism. A quadrotor aircraft is an example of this type of aircraft. In a quadrotor aircraft, four medium-sized rotors are all mounted with their thrust vectors pointing in the same downward direction. In this way, each rotor/fan would provide lift to support its corner of the aircraft, similar to how each leg of a table acts together to support the whole table. The fans could be arranged as in a diamond (with one fan in the front, one in the rear, one on the right, and one on the left) or they could be oriented like a rectangle (two fans on the left and two fans on the right). With either design, there is not a central swashplate. Rather, the total thrust of each rotor can be controlled either by varying the RPM of the rotor or by varying the pitch of each propeller. A mixing unit comprising a computer that reads pitch and roll commands outputted from the disclosed cascading control scheme would then output individual thrust commands to each of the 4 propellers. For example, if the control system executed a “bank right” command, then the mixing unit would command the fans such that the fan(s) on the left would provide more thrust (either by speeding up or increasing pitch), and the fan(s) on the right side would provide less thrust (either by slowing down or by decreasing pitch). Similarly a pitch forward command would result in more thrust from the rear fan(s) and less thrust from the front fan(s). A yaw command would cause the two clockwise spinning fans to speed up and the two counter-clockwise fans to slow down, assuming 2 fans run in one direction and 2 run the other. Alternatively, vane(s) could be used to redirect the airflow in such a way as to cause yaw motion. Under this topology, the Applicant's control system can be used in an identical manner as the traditional helicopter, since the inputs of to the mixer unit are identical to the inputs to the traditional helicopter's swashplate actuators.

A third design of VTOL aircraft only has three rotors. In this case, the mixer converts pitch and roll commands from the cascading control loops into motor/actuator commands that could cause pitch and roll movements. The primary differences of this topology is that yaw has to be achieved either with vectored thrust, or with one of the fans being substantially larger and rotating the opposite direction as the other two in order for the torques to cancel each other out. Again, with this topology, the Applicant's control system can be used in an identical manner as the traditional helicopter, since the inputs to the mixer unit are identical to the inputs to the traditional helicopter's swashplate actuators.

Thus, from the previous paragraphs, it should be clear that the type of craft and how it implements the pitch and roll commands is not a limiting factor. The Applicant's system merely outputs commands that are then converted to mechanical motions executed by an aircraft. Thus the Applicant's system, including both the translational movement sensing system and the control system, are sufficient to control virtually any topology of VTOL aircraft.

During remote operation of the aircraft, in some implementations, the remote operator can view the image observed by the on-board optic flow sensing video system. However, more commonly a separate video system would be used to provide images to the operator. As described below, this image can be stabilized to allow for easier viewing. The view may also be tilt stabilized to further ease operation. To pan left or right, the remote operator merely gives left/right commands that rotate the aircraft around the yaw axis. To look up or down, the remote operator gives commands to tilt the camera up or down, as described in the alternative embodiment of the invention portion of this application. In this manner the remote operator can look everywhere around and below the aircraft, while always maintaining a pilot's perspective such that forward is forward relative to the aircraft, and left is left relative to the aircraft etc. This drastically lessens the difficulties inherent in remotely piloting an aircraft. Because of the system's control over the aircraft, the operator does not need to have fast or precise reflexes to pilot the aircraft. Expected uses for the aircraft include law enforcement, surveillance, military use, building inspection, pipeline inspection, recreational use, and more.

### ALTERNATIVE EMBODIMENTS OF THE INVENTION

The principles of this invention can be applied to the flight of fixed-wing conventional aircraft. For example, the system could detect left-to right movement of a conventional fixed-wing aircraft relative to the ground. During landing and take-off, this data could be fed to a pilot or control system to aid in preventing unintended sideslip. The system could also determine the forward velocity of the aircraft relative to the ground, as opposed to traditional sensors that only determine forward velocity of the aircraft relative to the air. This data could be fed to the pilot or control system to provide groundspeed indication. Such features would be especially useful to manned aircraft during adverse weather conditions, or to unmanned aircraft when the pilot is located remotely. The data could also be fed into a control system to control the aircraft. For example, a position control loop for left/right control could automatically keep the aircraft at zero sideslip so that winds do not blow it off the runway. A velocity control loop could maintain the forward velocity of the aircraft relative to the ground, to a fixed value.

The sensor system could also be employed on a fixed-wing aircraft in a passive mode where it simply records position and velocity data to be fed into the onboard flight data recorder (FDR), to help aid in crash analysis. Since VTOL aircraft are inherently more difficult to autonomously control, application to them is preferred.

The principles of this invention could also be applied to manned vehicles as well as unmanned. Piloting a helicopter is a difficult skill to acquire, and by implementing portions of the disclosed system, assistance could be provided for training purposes, for conditions of extreme weather, for when particularly precise control is necessary, or for inherently unstable aircraft requiring precision and speed of control faster than what humans may provide.

In an additional alternative embodiment of the invention, a memory card can allow the storage of real-time in-flight data. Typical memory cards including but not limited to microSD Card, Memory Stick, or CompactFlash may be used. These and other data storing memory cards allow the aircraft to carry a “black box” capable of recording flight events and data, which is useful in analyzing the performance of the system, diagnosing problems, and failure analysis in the event of the loss of an aircraft.

In an additional alternative embodiment of the invention, an on-board camera in addition to the high-speed video capture system is present. This additional camera is moveable in pitch relative to the aircraft and is controllable by the operator of the aircraft. By using the video images from this camera to steer the craft, the operator will be observing a view similar to the view seen by an onboard pilot, and hence the relative position of the remote operator does not change as the aircraft moves and rotates in 3D space. The controls will never operate “backwards,” or “sideways” or “inverted” from the perspective of the operator. To further facilitate viewing and control, the image can be stabilized using conventional image stability techniques.

In an additional alternative embodiment of the invention, an infrared or visible light source may be placed on the ground so that the camera system can see it, or on the aircraft pointing towards the ground, to assist the vision system during low light conditions.

With respect to the above description then, it is to be realized that the disclosed equations and control loop figures may be modified in certain ways while still producing the same result claimed by the Applicant. Such variations are deemed readily apparent and obvious to one skilled in the art, and all equivalent relationships to those illustrated in the drawings and equations and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

I claim:

1. A method analyzing flight information of an aircraft, the method comprising the steps of:
a. producing a video stream from a vision sensing system wherein at least one object is tracked;
b. receiving attitude data from an attitude detecting device;
c. providing a computer capable of receiving and analyzing said video stream to obtain coupled optic flow data containing both aircraft rotational movement and aircraft translational movement relative to said at least one object being tracked; and
d. extracting decoupled aircraft translational movement data from said coupled optic flow data by utilizing said attitude data.

2. The method according to claim 1, the method further comprising the step of:
a. inputting said decoupled aircraft translational movement data into a cascading control loop algorithm in which an outer control loop algorithm determines a target angle and an inner control loop algorithm determines commands to cause said aircraft to achieve said target angle.

3. The method according to claim 1, the method further comprising the steps of:
a. recording a distance between said aircraft and said at least one object; and
b. applying a gain factor to said decoupled aircraft translational movement data, wherein said gain factor is proportional to said distance, and wherein said application step occurs subsequent to said distance recordation step.

4. The method according to claim 3, the method further comprising the step of:
a. inputting said decoupled aircraft translational movement data into a cascading control loop algorithm in which an outer control loop algorithm determines a target angle and an inner control loop algorithm determines commands to cause said aircraft to achieve said target angle, wherein said inputting step occurs subsequently to said gain factor application step.

5. The method according to claim 1 further comprising the step of intelligently controlling said aircraft using said decoupled translational movement data, said controlling step further comprising determining a current translational position of the aircraft.

6. The method according to claim 5, the method further comprising the step of:
a. inputting said decoupled aircraft translational movement data into a cascading control loop algorithm in which an outer control loop algorithm determines a target angle and an inner control loop algorithm determines commands to cause said aircraft to achieve said target angle.

7. The method according to claim 5, the method further comprising the steps of:
a. recording a distance between said aircraft and said at least one object; and
b. applying a gain factor to said decoupled aircraft translational movement data, wherein said gain factor is proportional to said distance, and wherein said application step occurs subsequent to said distance recordation step.

8. The method according to claim 7, the method further comprising the step of:
a. inputting said decoupled aircraft translational movement data into a cascading control loop algorithm in which an outer control loop algorithm determines a target angle and an inner control loop algorithm determines commands to cause said aircraft to achieve said target angle, wherein said inputting step occurs subsequently to said gain factor application step.

9. The method according to claim 8, wherein said intelligently controlling step further comprises the steps of:
a. using a force external to said aircraft to affect said aircraft translational movement such that said aircraft moves from a first position to a second position in an at least two dimensions; and
b. autonomously returning said aircraft to said first position from said second position, wherein said autonomously returning step occurs after said using step.

10. The method according to claim 1 further comprising the step of intelligently controlling said aircraft using said decoupled translational movement data, said controlling step further comprising determining a current velocity of the aircraft.

11. The method according to claim 10, the method further comprising the step of:
a. inputting said decoupled aircraft translational movement data into a cascading control loop algorithm in which an outer control loop algorithm determines a target angle and an inner control loop algorithm determines commands to cause said aircraft to achieve said target angle.

12. The method according to claim 10, the method further comprising the steps of:
a. recording a distance between said aircraft and said at least one object; and
b. applying a gain factor to said decoupled aircraft translational movement data, wherein said gain factor is proportional to said distance, and wherein said application step occurs subsequent to said distance recordation step.

13. The method according to claim 12, the method further comprising the step of:
a. inputting said decoupled aircraft translational movement data into a cascading control loop algorithm in which an outer control loop algorithm determines a target angle and an inner control loop algorithm determines commands to cause said aircraft to achieve said target angle, wherein said inputting step occurs subsequently to said gain factor application step.

14. A method analyzing flight information of an aircraft, the method comprising the steps of:
a. producing a video stream from a vision sensing system wherein at least one object is tracked;
b. receiving angular rate data from an angular rate detecting device;
c. providing a computer capable of receiving and analyzing said video stream to obtain coupled optic flow data containing both aircraft rotational movement and aircraft translational movement relative to said at least one object being tracked; and
d. extracting decoupled aircraft translational movement data from said coupled optic flow data by utilizing said angular rate data.

15. The method according to claim 14, the method further comprising the step of:
a. inputting said decoupled aircraft translational movement data into a cascading control loop algorithm in which an outer control loop algorithm determines a target angle and an inner control loop algorithm determines commands to cause said aircraft to achieve said target angle.

16. The method according to claim 14, the method further comprising the steps of:
a. recording a distance between said aircraft and said at least one object; and
b. applying a gain factor to said decoupled aircraft translational movement data, wherein said gain factor is proportional to said distance, and wherein said application step occurs subsequent to said distance recordation step.

17. The method according to claim 16, the method further comprising the step of:
a. inputting said decoupled aircraft translational movement data into a cascading control loop algorithm in which an outer control loop algorithm determines a target angle and an inner control loop algorithm determines commands to cause said aircraft to achieve said target angle, wherein said inputting step occurs subsequently to said gain factor application step.

18. The method according to claim 14 further comprising the step of intelligently controlling said aircraft using said decoupled translational movement data, said controlling step further comprising determining a current translational position of the aircraft.

19. The method according to claim 18, the method further comprising the step of:
a. inputting said decoupled aircraft translational movement data into a cascading control loop algorithm in which an outer control loop algorithm determines a target angle and an inner control loop algorithm determines commands to cause said aircraft to achieve said target angle.

20. The method according to claim 18, the method further comprising the steps of:
a. recording a distance between said aircraft and said at least one object; and
b. applying a gain factor to said decoupled aircraft translational movement data, wherein said gain factor is proportional to said distance, and wherein said application step occurs subsequent to said distance recordation step.

21. The method according to claim 20, the method further comprising the step of:
a. inputting said decoupled aircraft translational movement data into a cascading control loop algorithm in which an outer control loop algorithm determines a target angle and an inner control loop algorithm determines commands to cause said aircraft to achieve said target angle, wherein said inputting step occurs subsequently to said gain factor application step.

22. The method according to claim 20, wherein said intelligently controlling step further comprises the steps of:
a. using a force external to said aircraft to affect said aircraft translational movement such that said aircraft moves from a first position to a second position in an at least two dimensions; and
b. autonomously returning said aircraft to said first position from said second position, wherein said autonomously returning step occurs after said using step.

23. The method according to claim 14 further comprising the step of intelligently controlling said aircraft using said decoupled translational movement data, said controlling step further comprising determining a current velocity of the aircraft.

24. The method according to claim 23, the method further comprising the step of:
a. inputting said decoupled aircraft translational movement data into a cascading control loop algorithm in which an outer control loop algorithm determines a target angle and an inner control loop algorithm determines commands to cause said aircraft to achieve said target angle.

25. The method according to claim 23, the method further comprising the steps of:
a. recording a distance between said aircraft and said at least one object; and
b. applying a gain factor to said decoupled aircraft translational movement data, wherein said gain factor is proportional to said distance, and wherein said application step occurs subsequent to said distance recordation step.

26. The method according to claim 25, the method further comprising the step of:
a. inputting said decoupled aircraft translational movement data into a cascading control loop algorithm in which an outer control loop algorithm determines a target angle and an inner control loop algorithm determines commands to cause said aircraft to achieve said target angle, wherein said inputting step occurs subsequently to said gain factor application step.

27. The method according to claim 26, wherein said intelligently controlling step further comprises landing the aircraft.

28. A method for determining at least one of position or velocity of an aircraft, said method comprising the steps of:
a. Reading coupled video data comprising aircraft rotational data and aircraft movement data;
b. Recording inertial aircraft data in at least two dimensions; and
c. Decoupling said aircraft translational data from said coupled video data by compensating for said aircraft rotational data with said inertial aircraft data in at least two dimensions.

29. A method for determining at least one of position or velocity of an aircraft according to claim 28 wherein said inertial aircraft data in at least two dimensions comprises aircraft attitude data.

30. A method for determining at least one of position or velocity of an aircraft according to claim 28 wherein said inertial aircraft data in at least two dimensions comprises aircraft angular rate data.
